(19) United States
(12) Patent Application Publication
(10) Pub. No.: US 2009/0043478 A1
(43) Pub. Date: Feb. 12, 2009

(54) Method and device for monitoring an internal combustion engine with a duel fuel injection system

(75) Inventor: Daniel Joseph Labonte, Loves Park, IL (US)

Correspondence Address: LABONTE MOTORSPORTS, LLC, 12592 TWEED DR., LOVES PARK, IL, 61111, US

(73) Assignee: Labonte MotorSports, LLC, Rockford, IL (US)

(21) Appl. No.: 12/006,222

(22) Filed: Jan. 2, 2008

Related U.S. Application Data
(60) Provisional application No. 60/964,199, filed on Aug. 10, 2007.

(51) Int. Cl. F02B 47/04; F02D 3/00; G01F 1/00

(52) U.S. Cl. 701/103; 123/25 E; 73/114.42

(57) ABSTRACT

In a dual fuel injected internal combustion engine, the primary injected fuel is gasoline with a secondary fuel injected consisting of Ethanol, Methanol, a combination of Ethanol and Methanol or a mixture of either fuel with water. The method and device claimed is an electronic controller that monitors the flow rate and or effect of the secondary injected fuel though sensory input signals and outputs a control signal to an external device which will reduce the internal combustion engines power output to a safe level in the event that the flow of the secondary fuel injected is not within a predetermined specified range and or the effect of the secondary fuel injected is not within a predetermined range as detected by an automotive inlet air temperature sensor or automotive knock sensor there by preventing damage to the internal combustion engine from detonation or pre-ignition of the primary air fuel charge as a result of reduced quantity of secondary injected fuel. The external control device could reduce timing of the internal combustion engine spark event or reduce boost pressure of a forced induction system or increase fueling of the primary injected fuel upon receiving an output electrical signal from claimed monitoring device.

The electronic controller comprises of a housing with external connectors and internal components. One connector is a fluid inlet port located on the housing adapted to receive fluid into the housing. Another is a fluid output port located on the housing adapted to output the fluid from the housing. A third connector is a signal output connector located on the housing adapted to output an electrical signal.

### REFERENCE TO RELATED APPLICATIONS

This application claims priority to and incorporates fully by reference provisional application No. 60/964,199 filed on Aug. 10, 2007 entitled “Method and Device for monitoring an internal combustion engine with a duel fuel injection system.” The provisional application has at least the inventor in common with this application.

Portions of this claim have been copied from Pub. No. US 2007/0144485 A1 titled Water/Alcohol Injection Flow Switch Safety Device for purposes of initialing Interference Proceeding to determine rightful inventor.

### FIELD OF INVENTION

This invention generally relates to water injection systems for use with internal combustion engines.

### BACKGROUND OF THE INVENTION

Internal combustion gasoline engines have employed three different designs to increase the power output and efficiency of the engine. The first is a turbo charging system that compresses air into the engine though a turbine compressor that is rotated by expelled exhaust gas from the engine. The second is a supercharger system that compresses the air though rotating impellers that are driven by a belt coupled to the engine. The third is increasing the compression ratio of the engine where the piston has an increased downward travel distance to draw more air into the combustion chamber and the piston has increased upward travel distance to compress the air-fuel charge at higher pressures. In all three methods the temperature of the air forced or drawn into the engine is significantly increased. If the temperature of the engine gets to high, the fuel-air charge may spontaneously combust (known as pre-ignition or knock) and result in damage to the engine.

To reduce the engines in cylinder temperatures and reduce the probability of pre-ignition two methods are commonly used with the above mentioned designs. One is to add extra gasoline fuel to cool the cylinder during combustion. This extra gasoline fuel is not burnt during normal engine combustion and is burnt though after treatment processes such as a catalytic converter. The second method is to increase the gasoline fuels resistance to temperature induced spontaneous combustion though higher grade gasoline fuel know as the fuels octane value. Both of these methods result in gasoline fuel consumption inefficacies either though excess fuel consumption or burning higher grade fuel during periods of reduced pre-ignition probability such as when the engine is at idle or light loads.

Common methods employed to overcome the inefficacies in the use of excess fueling or higher grade fuel to prevent pre-ignition is the injection of a secondary liquid into the combustion process of the engine. Such secondary liquids can be the use of water, a mixture of water and alcohol, or a high octane rated alcohol fuel. The secondary liquid is injected into the engine air intake or directly injection into the engine combustion chamber. One such method is disclosed in U.S. Pat. No. 4,558,665 where water is used to cool the combustion chamber. A second method is disclosed in U.S. Pat. No. 5,400,746 where excess fuel is replace with injected water particles. A third method is disclosed in U.S. Pat. No. 7,287,509 where gasoline fuel is reduced and replaced with a higher octane rated alcohol fuel.

A limitation of the water-alcohol injection technology is when an incorrect amount of the secondary liquid is supplied to the engine combustion process. This may occur if the secondary fluid supply line becomes blocked, the secondary liquid is depleted, or otherwise. If the engine is deprived of the secondary liquid, the combustion chamber will not be properly cooled and is prone to pre-ignition or knock resulting in damage or total failure of the engine.

### SUMMARY OF THE INVENTION

The inventor of the present invention has recognized that water alcohol injection systems do not have a monitoring system in the event the water alcohol fluid stops flowing prematurely which would case an improper air to fuel mixture to enter the engine cylinder that is prone to pre-ignition and will damage the engine. Premature reduction in the injection of the secondary fluid can be the result of a failed pump, loss of fluid supply, or a clog in the system.

### BRIEF DESCRIPTION OF THE DRAWINGS

FIG. 1 is a diagram of a monitoring device coupled to water injection system and a gasoline engine.

FIG. 2 is a flowchart of the embodiment of the program for the monitoring device.

FIG. 3 is a diagram of the internal components of a monitoring device.

### DETAILED DESCRIPTION OF THE DRAWINGS

### Terminology:

The terms and phrases as indicated in quotation marks (“ ”) in this section are intended to have the meaning ascribes to them in this Terminology section applied to them throughout this document, including in the claims, unless clearly indicated otherwise in context. Further, as applicable, the stated definitions are to apply, regardless of the word or phrase's case, tense or any singular or plural variations of the defined word or phrase.

References in the specification to “one embodiment”, “an embodiment”, “a preferred embodiment”, “an alternative embodiment”, “a variation”, “one variation”, and similar phrases mean that a particular feature, structure, or characteristic described in connection with the embodiment is included in at least an embodiment of the invention. The appearances of phrases like “in one embodiment”, “in an embodiment”, or “in a variation” in various places in the specification are not necessarily all meant to refer to the same embodiment or variation.

The term “couple” or “coupled” as used in this specification and the appended claims refers to either an indirect or direct connection between the identified elements, components or objects. Often the manner in which the two coupled elements interact.

The term “or” as used in this specification and the appended claims is not meant to be exclusive rather the term is inclusive meaning “either or both”.

The term “integrate” or “integrated” as used in this specification and the appended claims refers to a blending, uniting, or incorporation of the identified elements, components or objects into a unified whole.

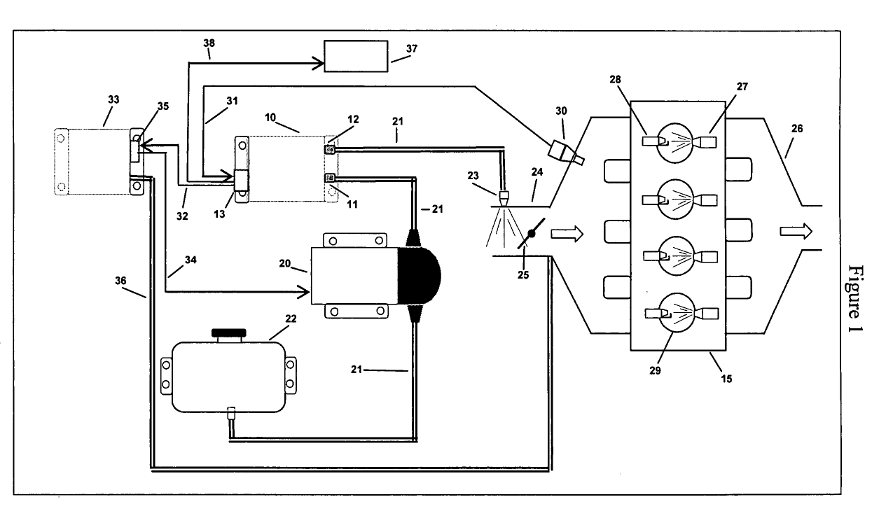

Referring to FIG. 1, an embodiment of a device for monitoring an internal combustion engine with a duel fuel injection system is displayed. The unit may also be referred to as a safety unit or as a water injection unit or device. One embodiment of a device for monitoring an internal combustion engine with a duel fuel injection system is comprised of a housing 10 having external connectors and internal components. The housing is adapted to be coupled near the engine of a vehicle, and in one version, the housing may be coupled under the hood of a car

An example of an internal combustion engine 15 is shown in FIG. 1. Engine 15 receives a supply of air though and intake manifold 24 and expellees combustion gases though exhaust manifold 26. Throttle plate 25 regulates the amount of air that enters the engine 15. Engine 15 consists of multiple piston cylinders 29 that receive a primary gasoline fuel by way of an injector 27 where there is one injector 27 per engine 15 piston cylinder 29. Air and fuel that enters the engine undergoes a controlled ignition by sparkplug 28 where there is one sparkplug for each piston cylinder 29.

The housing 10 of one embodiment includes 3 external connections. There is a signal connector 13, and a fluid input port 11, and a fluid output port 12 in a version. As best shown in FIG. 1, the fluid port connectors are each adapted to couple to, and exchange fluid with, a hose 21. The input fluid connector hose is further coupled to a pump 20 in one version. A hose further connects the pump to a fluid reservoir 22. The pump is adapted to take a water-alcohol mixture such as water-methanol from the reservoir to the fluid input port (also known as an input connector) upon receiving a signal to do so from a system control unit 33.

The secondary fluid injection system control box 33 receives power from a vehicle key-on source though an electrical connector 35 in one version. Other power sources may be used in the system. The key-on source may be selected by the installer. Therefore, in on variation, the control box receives a positive 12 volt power signal upon the ignition key of the vehicle being turned to the “on” position. The control box may send this power signal to the pump 20 along the control signal wire 34. The control signal wire may be tapped into so power to the monitoring unit 10 may be supplied. The monitoring unit may receive power through another source as well. The power is received at the monitoring unit by the signal output connector 13.

The secondary fluid flow may be initiated by the pump 20 receiving a signal from an injection system control box 33 informing the pump to do so. In one embodiment, the signal is sent from the control box, along a wire 34, to the pump. The wire 34 used to send the pump 20 a signal may be the control signal wire in an embodiment.

The output connector hose 21 is also coupled to a nozzle 23. The nozzle is adapted to spray a secondary fluid mixture into the engine air flow. Typically, the nozzle is coupled to the engine air intake 24 before the engine throttle plate 25, although the nozzle may be coupled to the engine 15 to inject the secondary fluid mixture into the air flow after the throttle plate as well.

Another embodiment would consist of the output connector hose 21 coupled to multiple nozzles 23, such that there is one nozzle for each cylinder 29 of the gasoline engine and each nozzle injects the secondary fluid into the respective cylinder.

The injection system control box 33 also includes a boost pressure source line 36 in on embodiment. One end of the boost pressure source line may be coupled to an engine air intake plenum 24. When boost pressure reaches a user-specified level, the control box sends a signal to the pump 20 to control injection flow.

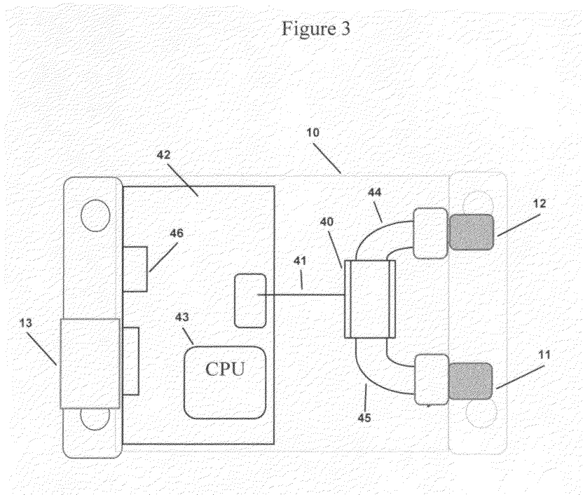

As best shown in FIG. 3, the fluid input port 11 is operatively coupled to a flow sensor 40 either directly or through tubing 45. In one embodiment the flow sensor may be a flow switch. One type of flow switch that my be used in an embodiment is a Type FS-4 flow switch, part number 213818, from Gems Sensors, Inc., located in Plainville, Conn. As best shown in FIG. 3, the flow switch has at least on input 45 adapted to receive water-methanol mixture from the input connector.

The FS-4 flow switch consists of a piston that may be set to magnetically activate a hermetically sealed switch at a specified flow rate. Therefore, after flow is initiated and mixture is flowing through the flow switch, in one embodiment, upon flow reaching a flow rate that is lower than an initial flow rate, the switch magnetically connects, and a 5 volt trigger signal is sent to the wire 41. One such flow rate that the switch is set to send a signal at is a flow rate of 0.1 liters per minute.

As best shown in FIG. 3, in one embodiment the flow sensor may comprise of a flow meter 40. The tubing may be coupled to the flow meter output and the output connector 12. The flow meter in one embodiment has a fluid input and a fluid output and is adapted to read the flow rate through the meter and provide a flow signal proportional to the flow rate to at least one wire 41. The flow meter wire is substantially similar to the flow switch wire.

Wire 41 is typically coupled to an electronic signal receptor 42. The electronic signal receptor may be an electronics board such as a circuit board. The signal output connector 13 may also be coupled to the electronic signal receptor. In one embodiment, the electronic signal receptor receives the electronic signal and transfers the signal to the signal output connector 13. The electronic signal receptor 42 may integrate a microprocessor 43 commonly called a Central Processing Unit or CPU.

One embodiment is also comprised of a switch. The switch is a trigger point switch 46. The switch may be a rotary dial. The dial may be accessible to the user from the outside surface of the unit, as best shown in FIG. 3. The dial may be capable of being adjusted with the use of a screwdriver. The trigger signal flow rate switch is coupled to the electronic signal receptor 42 in one version and may allow the user to set the flow rate at which the trigger signal is sent from the flow sensor. In one embodiment, the user may adjust the trigger point flow rate from 0.1 lpm to 0.8 lpm.

In one embodiment, CPU 43 is electronically coupled to the secondary fluid sensor 40, the adjustable trigger switch 46, the electronic signal connector 13 and the secondary fluid effect sensor 30.

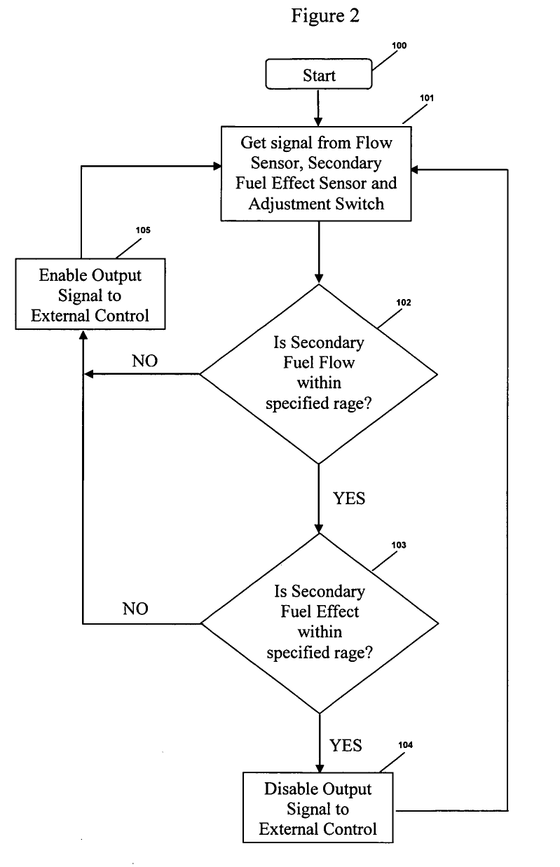

Referring to FIG. 2, the method of one embodiment of the present inventions starts at block 100 when the monitoring device receives a +12 volt signal from the external control device 33 or a Key-On voltage source. In block 101, the signals from the secondary fluid sensor, the secondary fluid effect sensor and the adjustment switch are computed. In block 102 the fluid sensor 40 signal is evaluated against the value of the adjustment switch 46 value. If the fluid senor signal is within the specified range, control is passed to block 103. If the fluid sensor signal is not with the specified range control is passed to block 105 in which the trigger output signal is enabled to an external device which will reduce the engine 15 power output to a safe level to prevent pre-ignition or knock that would otherwise damage the engine. In Block 103 the signal input from the secondary fuel effect sensor is evaluated against a preset value. If the evaluated value is determined to be within the predetermined range control is passed to block 104 otherwise control is passed to block 103. In Block 104 the Output signal to the external control device is disabled allowing the engine 15 to operate at normal power output level. Control is then passed to Block 101 where the method is restarted for continuous monitoring.

As best shown in FIG. 1, a +12 volt trigger signal is sent from the monitoring device 10 by the output connector 13 along wire 32. In one application the signal may be sent to an indicator. The indicator may be a dash mounted light emitting diode (LED). The signal may also be sent to an application control unit 37 along wire 38. The application control unit maybe adapted to change the ignition timing or adapt the level of boost that is entering the ignition cylinder of the engine. The change in ignition timing or boost is such that the engine 15 operates at a lower power output level which prevents pre-ignition or knock for the quantity of primary fuel entering the combustion cylinder 29 when the secondary injected fuel is reduced, not present or the effect of the secondary injected fuel is not measured.

As best shown in FIG. 1, one flow meter embodiment is a closed loop system. The signal receiving unit (control box 33) receives the signal and makes a comparison of the flow meter signal flow rate (the actual flow rate) to the flow rate that it originally sent to the pump 20 based on a boost signal. The boost signal may be boost pressure supplied by the boost pressure source line 36 coupled to gasoline engine 15. If the actual flow rate differs from the set flow rate, a new flow rate is set up or down to compensate for the difference. The new flow rate is sent to the pump over the wire and the pump sends a new secondary fluid volume to the monitoring unit 10.

In one embodiment the monitoring unit 10 may be coupled to a secondary sensor 30. This secondary sensor could be an air intake temperature sensor or an engine knock sensor as described in U.S. Pat. No. 6,246,953

While several methods for implementing the invention have been described in detail, those familiar with the art related to this invention will recognize other embodiments for implementing the invention. The above detailed embodiments are intended to be illustrative of the invention, which may be modified within the scope of the following claims.

I claim:

1. A water/alcohol injection monitoring device comprising:
a housing;
a fluid input port located on the housing adapted to receive a fluid into the housing;
a fluid output port located on the housing adapted to output the fluid from the housing;
a signal output connector located on the housing adapted to output an electrical signal therefrom a set period of time after a fluid flow rate between the fluid input and fluid output dropped below a predetermined level; and
an adjustable switch located on the housing to adjust the trigger point of the secondary fluid flow sensor.

2. The water/alcohol injection monitoring device of claim 1, wherein the adjustment switch comprises a rotary dial.

3. The water/alcohol injection monitoring device of claim 1, further comprising a flow sensor located within the housing between the fluid input and the fluid output and adapted to output a voltage when the fluid flow rate has dropped below the predetermined level.

4. The water/alcohol injection monitoring device of claim 3, adapted to receive a voltage signal from a secondary effect sensor at the electrical connector.

5. The water/alcohol injection monitoring device of claim 1, wherein the interior of the housing is potted with an epoxy material.

6. A water/alcohol injection monitoring device comprising:
a flow meter having a fluid input and a fluid output, the flow meter adapted to output a first signal proportional to a fluid flow rate through the flow meter; and
a flow meter circuitry adapted to output (i) a binary second signal at a signal output connector when the flow rate drops below a predetermined level as determined based on the first signal, and (ii) the first signal to the a second signal output connector.
a secondary effect sensor input circuitry adapted to read (i) a binary second signal at a signal output connector when the engine intake air temp rises above a predetermined level or engine knock is occurring.

7. A water/alcohol injection system comprising (a) the water/alcohol injection monitoring device of claim 1, (b) a fluid pump, and (c) a pump controller with (i) the pump controller being electrically coupled to the water/alcohol injection monitoring device by way of the second signal output connector, (ii) the pump being electrically coupled to the pump controller, and (iii) the water/alcohol injection monitoring device being fluidly coupled to the pump by way of the fluid input port, the pump controller further including a boost input sure of an associated internal combustion engine.

8. A method of operating the water/alcohol injection system of claim 7, the method comprising:
receiving the boost signal into the boost controller by way of the boost input;
determining an optimum fluid flow rate at the boost controller based on the boost signal;
sending electrical current to the pump to cause the pump to operate at a level necessary to obtain the optimum fluid flow rate;
measuring the fluid flow rate at the water/alcohol injection monitoring device;
sending the first signal to the boost controller from the water/alcohol injection safety device;
receiving the first signal at the boost controller; and
changing the electrical current sent to the pump based on the first signal to adjust the operational level of the pump to more obtain the optimum flow rate

9. The method of claim 8, cyclically repeating the operations of said receiving the boost signal, said determining an optimum fluid flow rate, said sending electrical current to the pump, said measuring the fluid flow rate, said receiving the first signal, said changing the electrical current sent to the pump, and said changing the electrical current sent to the pump.

10. The method of claim 8, wherein said determining an optimum fluid flow rate further comprises accessing a lookup table stored in a memory circuit in the boost controller.

11. The method of claim 8, wherein claimed monitoring device enables or disables a signal to reduce engine power output based on sensory input in claim 6.

12. The water/alcohol injection monitoring device of claim 6 further comprising a user adjustable trigger signal flow rate switch to set the predetermined level.
